(19) United States
(12) Patent Application Publication
(10) Pub. No.: US 2020/0272249 A1
(43) Pub. Date: Aug. 27, 2020

(54) MOUSE WITH FINGERPRINT IDENTIFICATION MODULES

(71) Applicant: Yung-Lung Liu, Taichung City (TW)

(72) Inventor: Yung-Lung Liu, Taichung City (TW)

(21) Appl. No.: 16/284,307

(22) Filed: Feb. 25, 2019

(51) Int. Cl. G06F 3/038; G06F 3/0354; G06K 9/00

(52) U.S. Cl. CPC G06F 3/0383; G06K 9/00087; G06F 3/03543

(57) ABSTRACT

A mouse includes a housing, a circuit board, a plurality of fingerprint identification modules, a plurality of wires, and a microprocessor. The housing includes a plurality of cavities on a top, each cavity being configured to receive one of the fingerprint identification modules. The circuit board is disposed in the housing and electrically connected to the microprocessor. The microprocessor is disposed on the circuit board and electrically connected to the fingerprint identification modules. Each wire is interconnected one of the fingerprint identification modules and the circuit board.

### BACKGROUND OF THE INVENTION

### 1. Field of the Invention

The invention relates to computer mice and more particularly to a mouse having a plurality of fingerprint identification modules mounted on a top.

### 2. Description of Related Art

U.S. Pat. No. 10,180,730 to Liu, entitled “keyboard having fingerprint identification modules”, discloses a keyboard comprising a plurality of key caps, a plurality of bridge structures, a circuit board, a plurality of resilient members, a plurality of fingerprint identification modules, a microprocessor, and an aluminum board wherein each key cap is disposed on top of the bridge structure; each bridge structure is pivotably disposed on top of the aluminum board; the circuit board is disposed between the bridge structures and the aluminum board; each resilient member is disposed between the key cap and the circuit board; each fingerprint identification module is disposed on the key cap and electrically connected to the circuit board; the microprocessor is disposed on the circuit board and electrically connected to the fingerprint identification modules; and the aluminum board is configured to support the circuit board from below and includes a plurality of pivotal seats on a top, each pivotal seat passing through the circuit board to fasten the bridge structure, the circuit board, and the aluminum board together.”

U.S. Pat. No. 6,337,919 to Dunton discloses a mouse comprising a substantially radiation transmissive mouse button; a fingerprint sensor to capture an image of a fingerprint when the user's finger is positioned over the mouse button; the fingerprint sensor comprising a light source to direct light through the mouse button, an optical, system for receiving light reflected from the user's finger over the mouse button and a sensor, wherein the light source, optical system and sensor are mounted to move with the mouse button. In short, radiation directed at the user's finger through the mouse button may be captured for image analysis and ultimately for fingerprint identification. Thus, the mouse may be used to identify users who wish to access a computer system.

While these devices enjoy their success in the market, continuing improvements in the exploitation of computer mouse with security features are constantly being sought.

### SUMMARY OF THE INVENTION

It is therefore one object of the invention to provide a mouse comprising a housing, a circuit board, a plurality of fingerprint identification modules, a plurality of wires, and a microprocessor wherein the housing includes a plurality of cavities on a top, each cavity being configured to receive one of the fingerprint identification modules; the circuit board is disposed in the housing and electrically connected to the microprocessor; the microprocessor is disposed on the circuit board and electrically connected to the fingerprint identification modules; and each of the wires is interconnected one of the fingerprint identification modules and the circuit board.

The above and other objects, features and advantages of the invention will become apparent from the following detailed description taken with the accompanying drawings.

### BRIEF DESCRIPTION OF THE DRAWINGS

FIG. 1 is a perspective view of a mouse according to the invention;

FIG. 2 is a view similar to FIG. 1 with the capacitance fingerprint sensors disengaged;

FIG. 3 is a longitudinal sectional view of the mouse of FIG. 1;

FIG. 4 schematically depicts the capacitance fingerprint sensor being touched by the finger; and

FIG. 5 is a block diagram of the fingerprint image acquisition and processing device incorporated into the mouse of the invention.

### DETAILED DESCRIPTION OF THE INVENTION

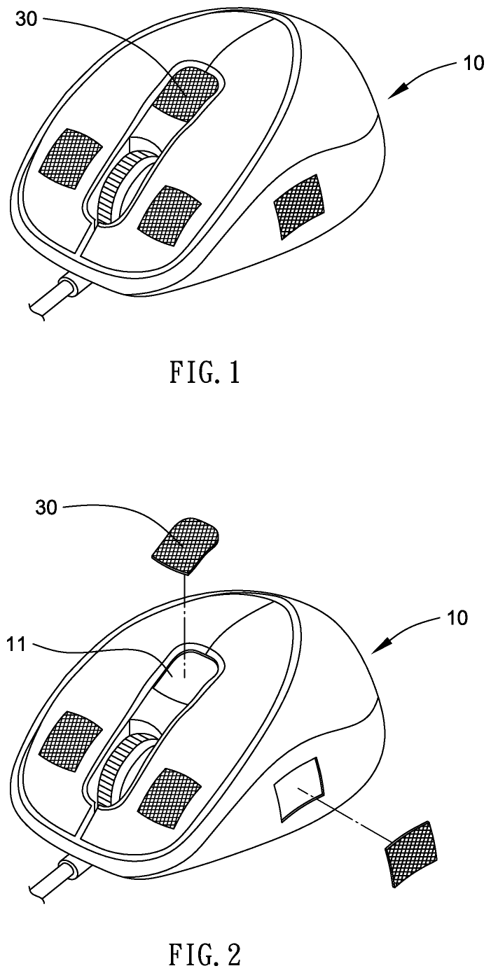

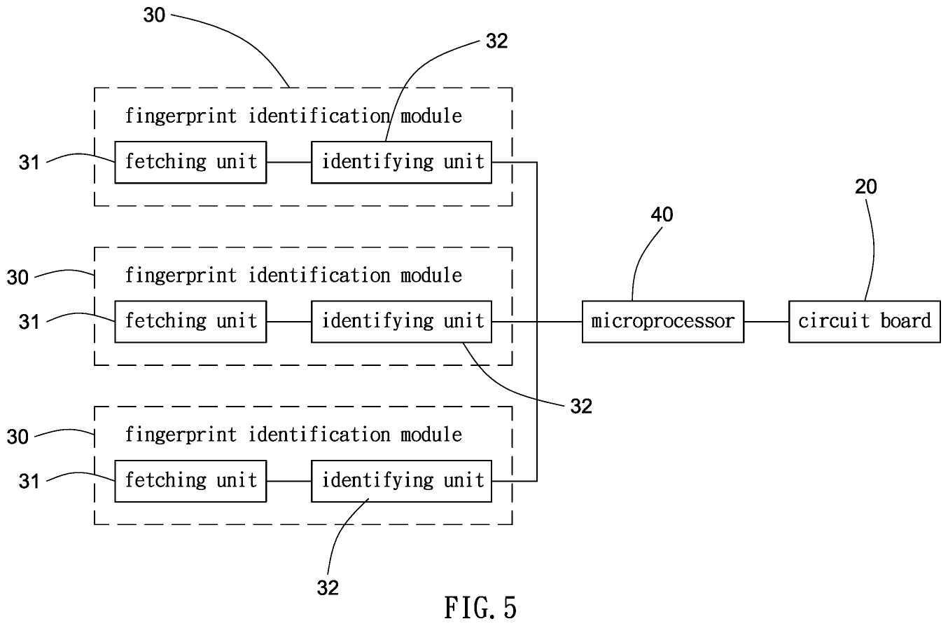

Referring to FIGS. 1 to 5, a mouse in accordance with the invention comprises a housing 10, a circuit board 20, a plurality of fingerprint identification modules 30 and a microprocessor 40 as discussed in detail below.

The housing 10 includes a scroll wheel (not labeled) and left and right mouse buttons (not labeled). The housing 10 is well known in the art. Thus, its detailed description is omitted herein for the sake of brevity. The housing 10 further comprises a plurality of cavities 11 on a top. The fingerprint identification module 30 is disposed in the cavity 11.

The circuit board 20 is disposed in the housing 10 and electrically connected to the microprocessor 40. The fingerprint identification module 30 is electrically connected to the circuit board 20.

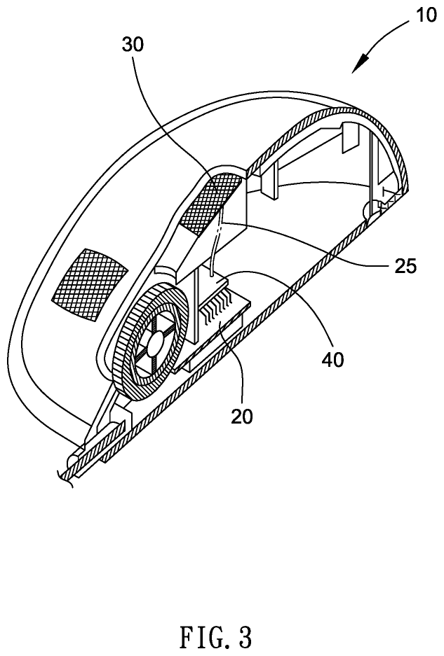

As shown in FIG. 3 specifically, one of a plurality of wires 25 is interconnected the fingerprint identification module 30 and the circuit board 20. The fingerprint identification module 30 includes a fetching unit 31 for capturing a user's fingerprint when the user's finger is positioned on the fingerprint identification module 30, and an identifying unit 32 for converting the user's fingerprint into fingerprint signals.

The microprocessor 40 is disposed on the circuit board 20 and electrically connected to the fingerprint identification module 30. The microprocessor 40 is configured to receive the fingerprint signals, analyze same, and ultimately identify the fingerprint. Thus, the mouse may be used to identify users who wish to access a computer.

The fingerprint identification module 30 is implemented as a semiconductor sensor having a plurality of sensing electrodes for capturing a digital image of ridges and valleys of a fingerprint pattern.

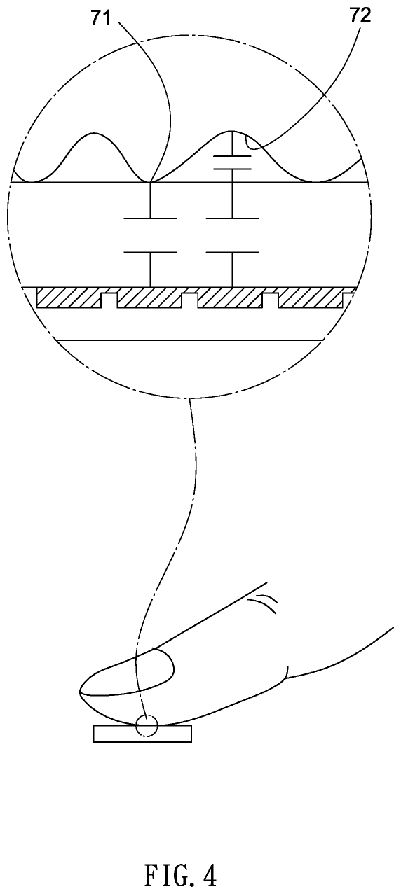

As shown in FIG. 4 specifically, there is a difference between capacitance of a ridge 72 of the fingerprint and capacitance of a valley 71 of the fingerprint when the user's finger is positioned on the fingerprint identification module 30. Thus, the fingerprint identification module 30 may capture the user's fingerprint.

While the invention has been described in terms of preferred embodiments, those skilled in the art will recognize that the invention can be practiced with modifications within the spirit and scope of the appended claims.

What is claimed is:

1. A mouse comprising a housing, a circuit board, a plurality of fingerprint identification modules, a plurality of wires, and a microprocessor wherein:
the housing includes a plurality of cavities on a top, each cavity being configured to receive one of the fingerprint identification modules;
the circuit board is disposed in the housing and electrically connected to the microprocessor;
the microprocessor is disposed on the circuit board and electrically connected to the fingerprint identification modules; and
each of the wires is interconnected one of the fingerprint identification modules and the circuit board.

2. The mouse of claim 1, wherein the fingerprint identification module includes a fetching unit for capturing a user's fingerprint when the user's finger is positioned on the fingerprint identification module, and an identifying unit for converting the user's fingerprint into fingerprint signals.

3. The mouse of claim 1, wherein the fingerprint identification module is a semiconductor sensor for capturing a digital image of ridges and valleys of a fingerprint pattern.
